(19) United States
(12) Patent Application Publication
(10) Pub. No.: US 2024/0410800 A1
(43) Pub. Date: Dec. 12, 2024

(54) CYLINDER HOLDERS FOR TEST MACHINES

(71) Applicant: Illinois Tool Works Inc., Glenview, IL (US)

(72) Inventor: Daniel James Carnazza, Quincy, MA (US)

(21) Appl. No.: 18/741,297

(22) Filed: Jun. 12, 2024

Related U.S. Application Data
(60) Provisional application No. 63/507,622, filed on Jun. 12, 2023.

(51) Int. Cl. G01N 3/04; G01N 3/08

(52) U.S. Cl. CPC G01N 3/04; G01N 3/08

(57) ABSTRACT

Disclosed example cylinder holder for a test machine include: a first block and a second block; a kinematic linkage configured to control positions of the first block and the second block to be equidistant from a centering point on a positioning surface; and an actuator configured to manipulate the kinematic linkage to urge the first block and the second block toward or away from the centering point.

### FIELD OF THE DISCLOSURE

The present disclosure is directed to specimen testing and, more particularly, to cylinder holders for test machines.

### BACKGROUND

Since the early part of the 20^{th} century, containers (e.g., bottles, vials, etc.) with elastomeric closures and, in some cases, crimped caps have been a primary packaging system for parenteral (i.e., injectable) medicines. Parenteral products contained in such container package systems require a robust seal at the interface between the glass container and the elastomeric stopper to prevent contamination and product leakage. While the seal is established in the manufacturing process, it must withstand a variety of handling, processing, and storage conditions prior to use. Many such containers are cylindrical in shape, but may have a variety of diameters.

### SUMMARY

Cylinder holders for test machines are disclosed, substantially as illustrated by and described in connection with at least one of the figures.

### BRIEF DESCRIPTION OF THE DRAWINGS

The foregoing and other objects, features, and advantages of the devices, systems, and methods described herein will be apparent from the following description of particular embodiments thereof, as illustrated in the accompanying figures; where like or similar reference numbers refer to like or similar structures.

FIG. 1 illustrates a perspective view of an example testing system in accordance with aspects of this disclosure.

FIG. 2 is a block diagram representative of the example testing system of FIG. 1.

FIG. 3A is a perspective view of an example cylinder holder that may be used to implement the cylinder holder of FIG. 2, at a first position.

FIG. 3B is a perspective view of the cylinder holder of FIG. 3A securing an example vial having a first size.

FIG. 3C is a perspective view of the cylinder holder of FIG. 3A at a second position.

FIG. 3D is a perspective view of the cylinder holder of FIG. 3A securing an example vial having a second size.

FIG. 4 is an exploded view of the example cylinder holder of FIGS. 3A-3D.

FIG. 5 is a top, partially transparent plan view of the example cylinder holder of FIGS. 3A-3D.

FIG. 6 is an exploded view of yet another example cylinder holder, including an pneumatically controlled actuator, that may be used to implement the cylinder holder of FIGS. 1 and 2.

FIG. 7 is an exploded view of yet another example cylinder holder, including an electrically controlled actuator, that may be used to implement the cylinder holder of FIGS. 1 and 2.

The figures are not necessarily to scale, emphasis instead being placed upon illustrating the principles of the devices, systems, and methods described herein.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

Conventional residual seal force testing devices rely on different fixtures to test different sizes of vials or containers. When a vial or container size is introduced or changed, a test fixture is required to be designed or purchased to properly align the vial in the testing machine. Maintaining inventories of such fixtures can be expensive and time-consuming.

Disclosed example testing systems and cylinder holders secure and align vials, cartridges, and/or other cylindrical containers having a range of diameters using a single fixture device. Additionally, disclosed example testing systems and cylinder holders are easy to operate and do not require substantial reconfiguration to adjust for differently sized cylinders. In a disclosed example, an operator can pull a plunger to move securing blocks to an open or expanded position, position the cylinder on a positioning surface, and release the plunger to both secure and align the cylinder with a centering point, which is aligned with a load string of a testing system. Disclosed example cylinder holders include alignment features in multiple alignment directions, such that the operation of securing the cylinder in the cylinder holder also adjusts the position of the cylinder to perform alignment.

Disclosed example cylinder holders are largely or wholly compliant with wipedown procedures which may be required in some testing facilities.

As used herein, the terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. The terms “e.g.,” and “for example” set off lists of one or more non-limiting examples, instances, or illustrations. No language in the specification should be construed as indicating any unclaimed clement as essential to the practice of the embodiments.

As used herein, the term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

As used herein, the terms “circuit” and “circuitry” includes any analog and/or digital components, power and/or control elements, such as a microprocessor, digital signal processor (DSP), software, and the like, discrete and/or integrated components, or portions and/or combinations thereof.

As used herein, the terms “drivingly coupled,” “drivingly coupled to,” and “drivingly coupled with” as used herein, each mean a mechanical connection that enables a driving part, device, apparatus, or component to transfer a mechanical force to a driven part, device, apparatus, or component.

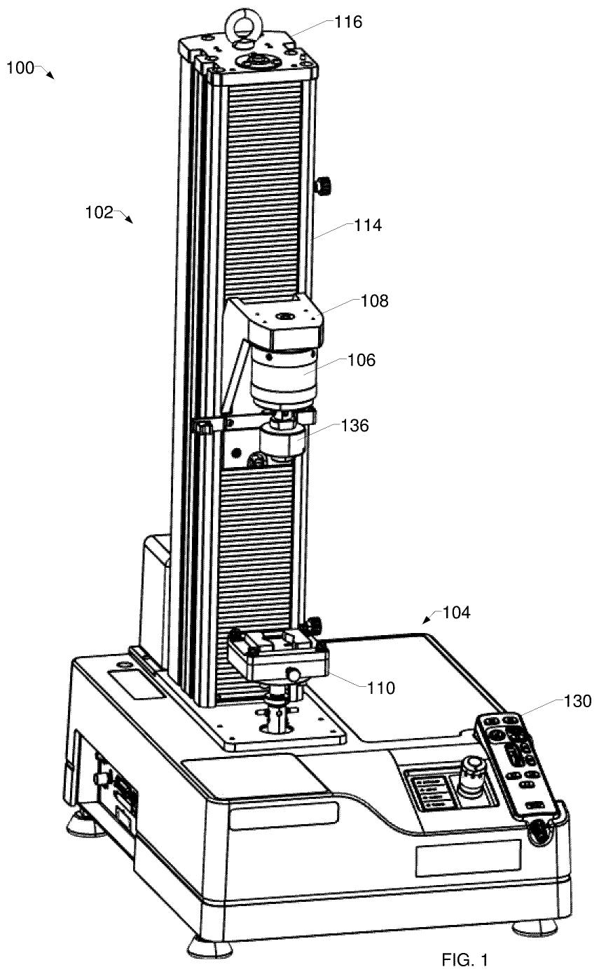

FIG. 1a illustrates perspective view of an example testing system 100, while FIG. 1b illustrates a perspective view of the load frame 102 of the example testing system 100 with portions omitted for clarity. The testing system 100 generally comprises a load frame 102, a load cell 106 mounted to a crosshead 108 of the load frame 102, and a cylinder holder 110 at a base structure 104 of the load frame 102. As will be discussed, the cylinder holder 110 is configured to support and align a specimen during compression testing (e.g., RSF or CF testing), whether through a manual or automated process.

As best illustrated in FIG. 1a, the load frame 102 comprises a base structure 104, one or more columns 114, a moving crosshead 108, and a top plate 116. The load frame 102 serves as a high stiffness support structure against which the test forces react (e.g., compressive forces) during a test (e.g., a RSF test, compression friction measurement test, etc.). While the load frame 102 may be composed of a single column 114, as illustrated, multiple columns 114 may be employed, for example, in a dual column arrangement. The base structure 104 generally serves to support the one or more columns 114 and a cylinder holder 110 that supports the specimen 112, while also housing various circuitry and components. An example implementation of the load frame 102, the base structure 104, the columns 114, the moving crosshead 108, and/or, more generally, the testing system 100, is disclosed in U.S. patent application Ser. No. 17/578,821, filed Jan. 19, 2022, and entitled “System, Method, and Apparatus for Automating Specimen Testing.” The entirety of U.S. patent application Ser. No. 17/578,821 is incorporated herein by reference.

The cylinder holder 110 may be manually or automatically adjusted (or otherwise controlled) to move or transfer a specimen to a testing position, which is typically aligned below a test head 136, test apparatus, or other test accessory. The cylinder holder 110 may have a centering point which is aligned with a test axis of the test head 136. The specimen 112 may be, for example, a container for a parenteral pharmaceutical product, or other cylindrical container.

Each of the one or more columns 114 comprises a guide column and a ballscrew that is drivingly coupled to an actuator. A ballscrew is a form of mechanical linear actuator that translates rotational motion (e.g., from an actuator, such as a motor) to linear motion with little friction. In one example, the ballscrew may include a threaded shaft that provides a helical raceway for ball bearings, which acts as a precision screw. The ballscrew is housed within the one or more columns 114 between the base structure 104 and the top plate 116. The actuator that drives the ballscrew is controlled via a controller. A column cover may be provided to protect the ballscrew from dirt, grime, and damage, while also protecting the user from harm during operation. The testing system 100 comprises various sensors to monitor its operation. For example, the testing system 100 may include an upper limit switch and/or a lower limit switch to prevent the crosshead 108 from deviating from an acceptable range of motion along the test axis. Upon triggering the upper limit switch or the lower limit switch, the controller may stop (or reverse) the actuator to prevent damage to the testing system 100 or the specimen.

The crosshead 108 is mounted to both the guide column and the ballscrew and supports the load cell 106. The ballscrew is driven (e.g., rotated) via an actuator. Rotation of the ballscrew drives the crosshead 108 up (away) or down (toward) relative to the base structure 104, while the guide column provides stability to the crosshead 108. The load cell 106 may be removably coupled to the crosshead 108 via one or more mechanical fasteners (e.g., screws, bolts, socket head cap screws, etc.) to enable the operator to exchange the load cell 106 when desired. For example, the load cell 106 may become damaged, a different type of load cell 106 may be desired or needed, which can vary by test (e.g., RSF and CF testing).

The testing system 100 may include a display device (e.g., a touch screen display), a control panel, a remote control 130 (e.g., a handset) may be used by the operator to monitor and/or control operation of the testing system 100. In some example, the control panel and/or the remote control 130 may each provide one or more switches, buttons, or dials to control or adjust operation of the testing system 100 (e.g., an emergency stop button). The control panel and/or the remote control 130 may further provide one or more status indicators (e.g., LEDs, lights, etc.) to provide a status of the testing system 100. The remote control 130 may be wired or wireless.

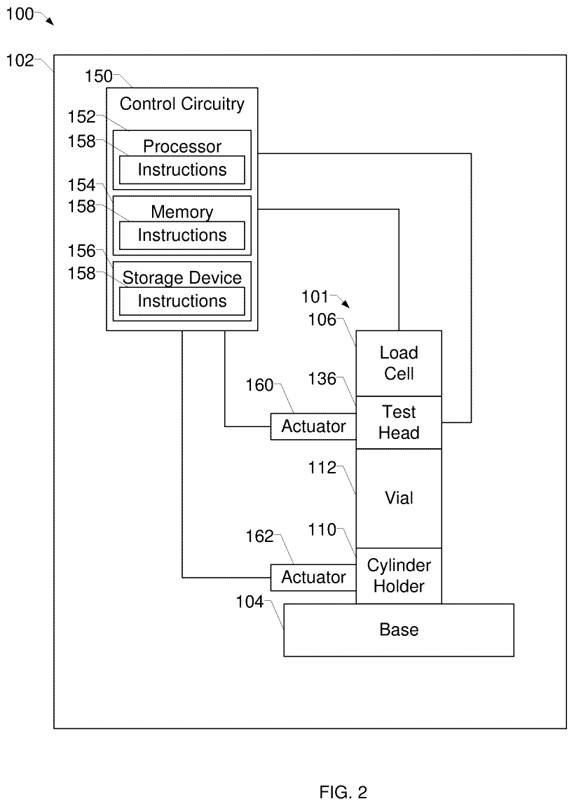

FIG. 2 is a block diagram representative of the example testing system 100 of FIG. 1. As illustrated in FIG. 2, a load string 101 generally refers to the components installed between the moving crosshead 108 and the base structure 104 (or, where applicable, a fixed lower crosshead). Typically, the load string 101 includes the load cell 106, the test head 136, any adapters required to connect the components, and the specimen(s) 112 to be tested. Typically, for RSF testing, the load cell 106 is mounted on the crosshead 108, a test head 136 with an anvil is mounted to the load cell 106, and a specimen 112 is positioned on the base structure 104 (e.g., using a cylinder holder 110). Similarly, for CF testing, a load cell 106 is mounted on the crosshead 108, a compression rod is mounted to the load cell 106, and a specimen 112 is positioned on the base structure 104 (e.g., using a cylinder holder 110).

Operation of the testing system 100 may be automatically controlled and/or monitored via control circuitry 150. The control circuitry 150 may comprise a processor 152 and memory device 154 configured with executable instructions. The control circuitry 150 is operably coupled to, and configured to control, the various actuators, such as an actuator 160 that drives the test head 136 via a ballscrew, sensors (e.g., load cell(s) 106, upper and lower limit switches, etc.), user interfaces (e.g., a display device, a control panel, the remote control 130, etc.), an actuator 162 that controls the cylinder holder 110, and/or other elements.

The control circuitry 150 may be a general-purpose computer, a laptop computer, a tablet computer, and/or any other type of processing system configured to communicate with the sensors and actuators of the testing system 100. The example processor 152 may be any general purpose central processing unit (CPU) from any manufacturer. In some other examples, the processor 152 may include one or more specialized processing units, such as RISC processors with an ARM core, graphic processing units, digital signal processors, and/or system-on-chips (SoC). The processor 152 executes machine readable instructions 158 that may be stored locally at the processor (e.g., in an included cache or SoC), in the memory 154 (e.g., a random access memory or other volatile memory, a read only memory or other non-volatile memory such as FLASH memory, and/or in the storage device 156. The example storage device 156 may be a hard drive, a solid state storage drive, a hybrid drive, a RAID array, and/or any other mass data storage device.

During the RSF test, for example, the crosshead 108 moves down along a test axis of the load frame 102 (toward the base structure 104) to apply compressive load to a specimen 112 (e.g., a vial, cartridge, or other cylinder) via a test head 136, test apparatus, or other test accessory that is coupled to the load cell 106. The test head 136 may be, or include, an anvil (also known as a dorn) configured to contact and compress the specimen 112. The test head 136, test apparatus, or other test accessory may be coupled directly to a coupler of the load cell 106 or via a compression rod or pin. While examples systems, apparatus, and methods are disclosed herein with reference to vials, the disclosed examples may be used with cartridges and/or any other cylindrical containers.

The load cell 106 converts this load into an electrical signal that the testing system 100 measures via control circuitry 150. In one example, the test head 136 may advance at a constant speed (e.g., about 0.01 inches/second). In other words, in this example, for every 0.001 inches the crosshead 108 travels along the column 114 (along the test axis), the control circuitry 150 automatically records the force exerted by the specimen 112 in response to the movement (strain) imposed upon the specimen 112 by the test head 136. The constant speed may be adjusted for a given specimen 112. The control circuitry 150 also automatically records the corresponding strain data. The resulting data set comprises a sequence of stress-strain measurements that can be graphed, which approximates a curve of predictable shape.

The test head 136 may be designed for RSF and/or CF testing. For example, the test head 136 may be a compression rod for CF testing or include an anvil for RSF testing, such as a test head with an adjustable, conforming anvil. As can be appreciated, certain tests may warrant a specific type of test head 136. For example, the test head 136 used during RSF measurement may include an anvil that is sized and shaped to correspond to the size and shape of the closure of a parenteral container. Therefore, while the test head 136 is generally illustrated in FIG. 1 as being configured for RSF testing, a compression rod (and associated load cell) may instead be used for CF testing.

The test head 136 can be interchangeable to enable the testing system 100 to be used for various types of tests (e.g., RSF, CF, tensile, compression, flexure, etc.). In other words, the test head 136 may be configured to removably couple with the load cell 106 via, for example, a coupler or other means to enable the operator to replace or interchange the test head 136 with another the test head 136, test apparatus, or other test accessory. The coupler may employ one or more of a collar coupling (e.g., a collar with one or more set pins or screws), clevis coupling, sleeve coupling, or a screw on coupling (e.g., a threaded rod). Therefore, while the coupler is illustrated as a female collar coupler with set screws and/or set pins, other types of couplings are contemplated.

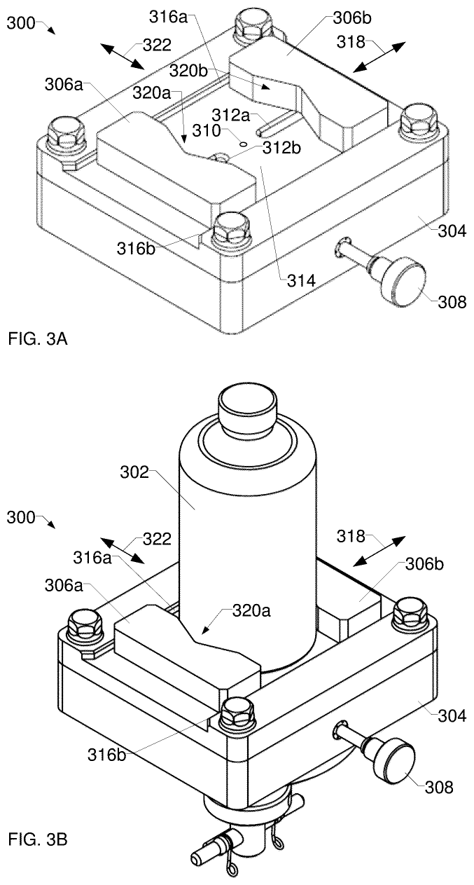

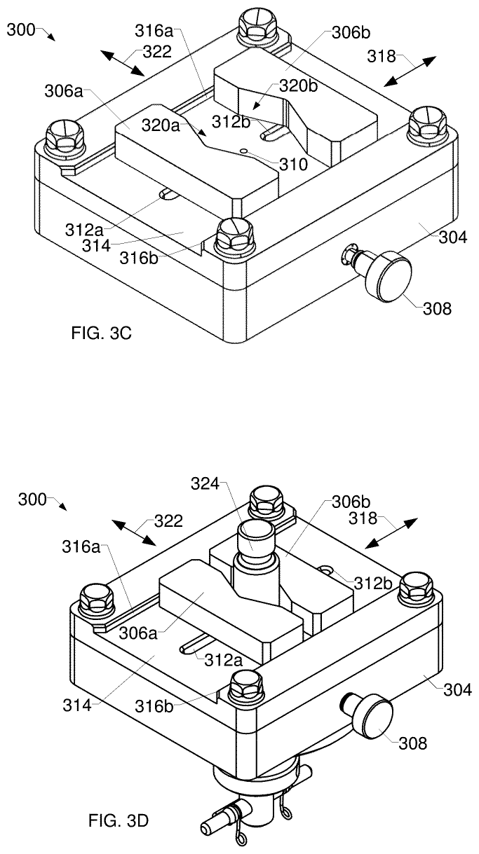

The specimen 112 is supported on the base structure 104 by the cylinder holder 110. In contrast with conventional vial holders, the cylinder holder 110 is capable of securing vials or other cylinders of different diameters, while also aligning the vial or other cylinder with the text axis of the test head 136. FIG. 3A is a perspective view of an example cylinder holder 300 that may be used to implement of the cylinder holder 110 of FIG. 2, at a first position. FIG. 3B is a perspective view of the cylinder holder 300 of FIG. 3A securing an example vial 302 having a first size.

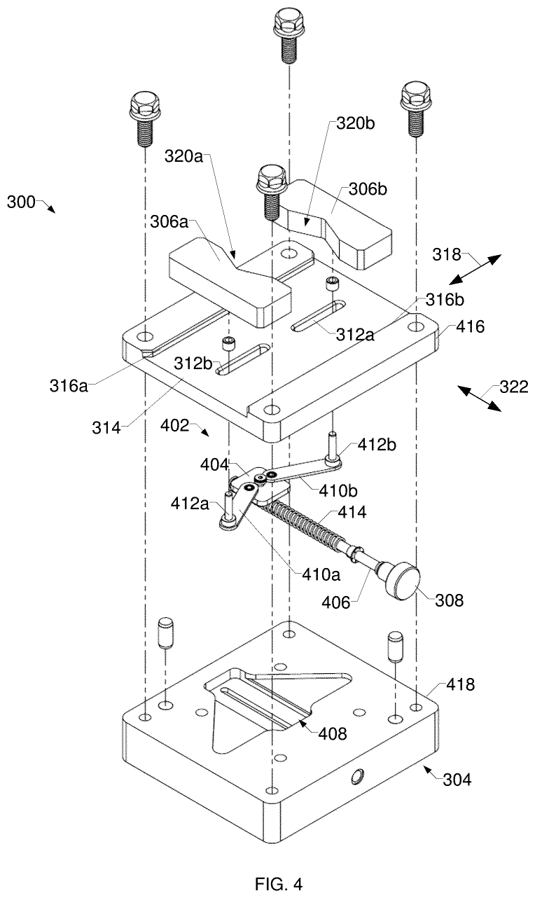

The example cylinder holder 300 of FIG. 3A includes a body 304, first and second blocks 306a, 306b, which are actuated to secure and align the vial 302. To move the first and second blocks 306a, 306b, the cylinder holder 300 includes an actuator (e.g., a plunger 308) which manipulates a kinematic linkage to control the positions of the first and second blocks 306a, 306b. As illustrated in more detail in FIG. 4, the first and second blocks 306a, 306b are controlled by the kinematic linkage to be equidistant from a centering point 310. The example cylinder holder 300 is coupled to the base 104 in the load string 101 such that the centering point 310 is aligned with the test axis of the load string 101 (e.g., in alignment with the test head 136, which may have a margin of error or range of effective alignment). For example the centering point 310 is set to be concentric to the compressive force applied by the test head 136 (e.g., within a predetermined tolerance, which may be determined based on the configuration of the test head 136).

The movements of the first and second blocks 306a, 306b are guided in linear directions by one or more slots 312a, 312b in a positioning surface 314 of the body 304. The kinematic linkage is connected to the blocks 306a, 306b through the slots 312a, 312b. The example body 304 further includes guide surfaces 316a, 316b, which further constrain the blocks 306a, 306b from rotating. The guide surfaces 316a, 316b may include tracks, rails, shoulders, and/or any other surface that constrains movement and/or rotation of the blocks 306a, 306b. However, in other examples, the guide surfaces 316a, 316b may be omitted and the blocks 306a, 306b may be constrained using additional slots in the positioning surface 314. The example blocks 306a, 306b further include notched surfaces 320a, 320b, or another shape, to align the vial 302 with the centering point 310 in a second alignment direction 322.

As the plunger 306 is pulled outwards from the body 304 (e.g., manually, via a biasing element, via an electronic, pneumatic, or hydraulic actuator, etc.), the kinematic linkage causes the blocks 306a, 306b to move linearly outward from the centering point 310 along a first alignment direction 318. As the blocks 306a, 306b move, the kinematic linkage controls the blocks 306a, 306b to remain equidistant from the centering point 310.

Conversely, as the plunger 306 is moved toward the body 304 (e.g., manually, via a biasing element, via an electronic, pneumatic, or hydraulic actuator, etc.), the kinematic linkage causes the blocks 306a, 306b to move linearly inward toward the centering point 310 along the first alignment direction 318. FIG. 3C is a perspective view of the cylinder holder of FIG. 3A at a second position, in which the plunger 308 is closer to the body 304, and the blocks 306a, 306b are closer to the centering point 310, than in the position illustrated in FIG. 3A. As the blocks 306a, 306b contact the vial 302, the blocks 306a, 306b urge the vial 302 toward alignment with the centering point 310 in both the first alignment direction 318 (e.g., via the equidistant positioning and movement of the blocks 306a, 306b in the first alignment direction 318) and the second alignment direction 320 (e.g., via the notched surfaces 320a, 320b urging the vial 302).

The example cylinder holder 300 centers vials or other cylinders within a range of diameters. FIG. 3D is a perspective view of the cylinder holder of FIG. 3A securing an example vial 324 having a second size. As illustrated in FIGS. 3B and 3D, the cylinder holder 300 aligns both vials 302, 324 with the centering point 310.

In other examples, the kinematic linkage can be adapted to move the blocks 306a, 306b away from the centering point 310 as the plunger 306 is moved toward the body 304 and to move the blocks 306a, 306b toward the centering point 310 as the plunger 306 is moved away from the body 304.

FIGS. 3B and 3D further illustrate a mounting block 326, which couples the cylinder holder 300 to the base 104 to align the centering point 310 with the load string 101. In some examples, the base 104 includes a clamp or connector to grasp, accept, or otherwise connect to the mounting block 326. The mounting block 326 may be structured to automatically align the centering point 310 with the load string 101 when mounted to the base 104, and/or may include adjustments to allow for manual and/or automatic alignment of the centering point 310 with the load string 101 while the mounting block 326 is connected to the base 104.

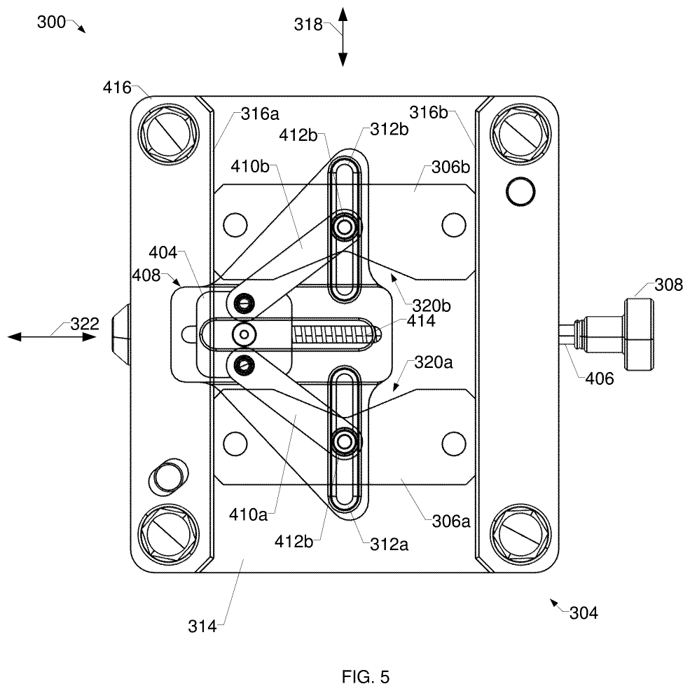

FIG. 4 is an exploded view of the example cylinder holder 300 of FIGS. 3A-3D. As discussed above, the cylinder holder 300 includes the body 304, the first and second blocks 306a, 306b, the plunger 308, the slots 312a, 312b, the positioning surface 314, the guiding surfaces 316a, 316b, and the notched surfaces 320a, 320b. FIG. 4 further illustrates an example kinematic linkage 402, which couples the plunger 308 to the blocks 306a, 306b, and controls movement of the blocks 306a, 306b. FIG. 5 is a top, partially transparent plan view of the example cylinder holder 300 of FIGS. 3A-3D.

The example kinematic linkage 402 includes a linkage plate 404 connected to the plunger 308 via a plunger rod 406. The plunger rod 406 moves the linkage plate 404 along a groove 408 (or slot, or channel) in the body 304. The groove 408 extends in a transverse direction to the slots 312a, 312b, and may be shaped to limit the linkage plate 404 to linear translation, and restrict rotation and/or the length for translation.

The linkage plate 404 is further rotationally coupled to arms 410a, 410b, which connect to respective ones of the first and second blocks 306a, 306b via posts 412a, 412b through the slots 312a, 312b. As the linkage plate 404 is translated along the groove 408 via the plunger 308 and the plunger rod 406, the arms 410a, 410b urge, via the posts 412a, 412b, the blocks 306a, 306b to move inwards or outwards with respect to the centering point 310 (e.g., in the first alignment direction 318).

The example kinematic linkage 402 further includes a biasing element 414, such as a spring, which urges the plunger 308 inward and, via the kinematic linkage 402, urges the blocks 306a-306b toward the centering point 310.

The example body 304 is constructed from an upper body 416 and a lower body 418. The upper body 416 includes the slots 312a, 312b and the positioning surface 314, and is attached to the lower body 418 via screws or other fasteners. The lower body 418 includes the groove 408 and other voids to allow the linkage plate 404 to move within a predetermined range of motion.

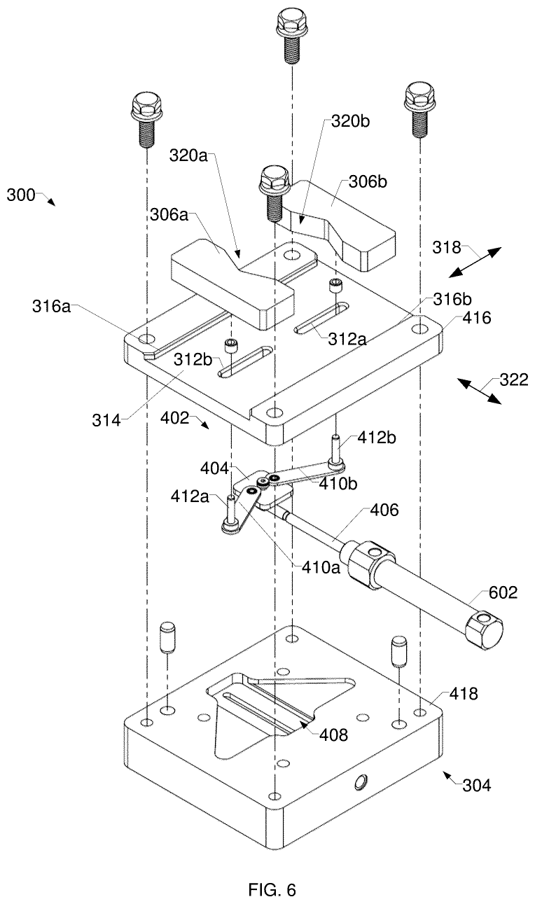

FIG. 6 is an exploded view of another example cylinder holder 600 that may be used to implement the cylinder holder 110 of FIGS. 1 and 2. The example cylinder holder 600 is similar to the cylinder holder 300 of FIGS. 3A-5, except that the plunger 308 and the biasing element 414 are replaced with a pneumatically controlled actuator 602 coupled to the linkage plate 404. The cylinder holder 600 includes the body 304 (e.g., the upper body 416 and the lower body 418), the first and second blocks 306a, 306b, the plunger 308, the slots 312a, 312b, the positioning surface 314, the guiding surfaces 316a, 316b, the notched surfaces 320a, 320b, the linkage plate 404, the arms 410a, 410b, and the posts 412a, 412b.

The example control circuitry 150 may control a gas source to energize the pneumatically controlled actuator 602 to control the blocks 306a, 306b via the kinematic linkage 402. For example, the control circuitry 150 may increase the pressure to secure a vial 302, 324 via the blocks 306a, 306b and/or reduce the pressure to release the vial 302, 324. In other examples, the pneumatically controlled actuator 602 may include an internal biasing element, such as a spring, to urge the plunger rod 406 in a first direction. The control circuitry 150 may control the gas source to actuate the pneumatically controlled actuator 602 in a second direction opposing the biasing element.

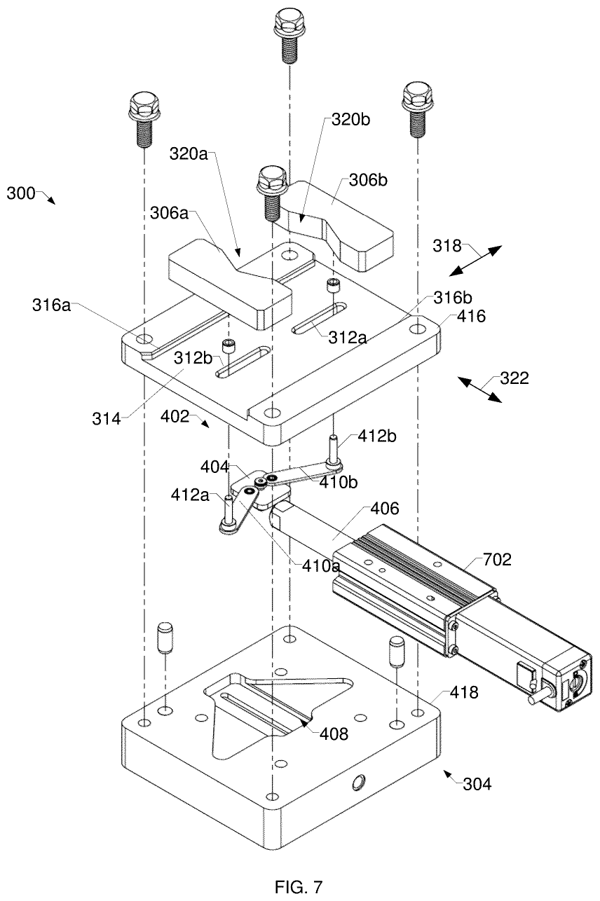

FIG. 7 is an exploded view of yet another example cylinder holder 700 that may be used to implement the cylinder holder 110 of FIGS. 1 and 2. The example cylinder holder 700 is similar to the cylinder holder 300 of FIGS. 3A-5, except that the plunger 308 and the biasing clement 414 are replaced with an electrically controlled actuator 702 coupled to the linkage plate 404. The cylinder holder 700 includes the body 304 (e.g., the upper body 416 and the lower body 418), the first and second blocks 306a, 306b, the plunger 308, the slots 312a, 312b, the positioning surface 314, the guiding surfaces 316a, 316b, the notched surfaces 320a, 320b, the linkage plate 404, the arms 410a, 410b, and the posts 412a, 412b.

The example control circuitry 150 may control the electrically controlled actuator 702 to control the blocks 306a, 306b via the kinematic linkage 402. For example, the control circuitry 150 may control the electrically controlled actuator 702 to actuate in a first direction to secure a vial 302, 324 via the blocks 306a, 306b and/or control the electrically controlled actuator 702 in a second direction to release the vial 302, 324. In other examples, the electrically controlled actuator 702 may include an internal biasing element, such as a spring, to urge the plunger rod 406 in a first direction. The control circuitry 150 may control the electrically controlled actuator 702 to actuate the electrically controlled actuator 702 in a second direction opposing the biasing element.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A cylinder holder for a test machine, comprising:
a first block and a second block;
a kinematic linkage configured to control positions of the first block and the second block to be equidistant from a centering point on a positioning surface; and
an actuator configured to manipulate the kinematic linkage to urge the first block and the second block toward or away from the centering point.

2. The cylinder holder as defined in claim 1, wherein the first block and the second block are moved via the kinematic linkage along a first linear direction, and at least one of the first block or the second block comprises a notched surface configured to center a vial with the centering point along a second direction.

3. The cylinder holder as defined in claim 1, wherein the actuator comprises a plunger configured to be actuated in a first direction to move the first block and the second block apart, and the biasing element is configured to urge the plunger in a second direction opposite the first direction.

4. The cylinder holder as defined in claim 1, further comprising a body comprising the positioning surface, the first block and the second block configured to be coupled to the body.

5. The cylinder holder as defined in claim 4, wherein the body comprises at least one slot configured to constrain movement of the first block and the second block.

6. The cylinder holder as defined in claim 5, wherein the kinematic linkage is coupled to the first block and the second block through the at least one slot.

7. The cylinder holder as defined in claim 5, wherein the body comprises an additional slot extending in a transverse direction to the at least one groove, the kinematic linkage comprising a link that is constrained by the additional groove.

8. The cylinder holder as defined in claim 4, wherein the body comprises a guide surface configured to constrain movement of the first and second blocks and to constrain rotation of the first and second blocks.

9. The cylinder holder as defined in claim 1, further comprising a mounting block configured to align the centering point with a load string of a universal testing machine.

10. The cylinder holder as defined in claim 1, wherein the vial holder is configured to center a vial on the centering point for a range of vial diameters.

11. The cylinder holder as defined in claim 1, wherein the actuator comprises a biasing element configured to urge the first block and the second block toward or away from the centering point.

12. The cylinder holder as defined in claim 1, wherein the actuator comprises at least one of an electrical actuator or a pneumatic actuator.

13. The cylinder holder as defined in claim 12, further comprising a controller configured to control the electrical actuator or the pneumatic actuator to move the first block and the second block toward or away from the centering point.

14. A residual seal force (RSF) testing system, comprising:
a test head configured to apply a compressive force to a vial or cartridge;
a load cell configured to measure the compressive force; and
a vial or cartridge holder, comprising:
a first block and a second block;
a kinematic linkage configured to control positions of the first block and the second block to be equidistant from a centering point on a positioning surface, the centering point being aligned with the compressive force applied by the test head; and
an actuator configured to manipulate the kinematic linkage to urge the first block and the second block toward or away from the centering point.

15. The RSF testing system as defined in claim 14, wherein the test head, the load cell, and the vial holder are configured to be coupled to a load string of a universal testing machine.

16. The RSF testing system as defined in claim 14, wherein the centering point is concentric to the compressive force applied by the test head.

17. The RSF testing system as defined in claim 14, further comprising control circuitry configured to:
control a second actuator to actuate the test head to apply the compressive force to the vial; and
monitor the load cell to determine a residual seal force based on at least one of the compressive force applied by the test head or a displacement of the test head.

18. The RSF testing system as defined in claim 17, wherein the control circuitry is configured to actuate the actuator to release or hold the vial via the first and second blocks and the kinematic linkage.
